(19) United States
(12) Patent Application Publication
(10) Pub. No.: US 2026/0230983 A1
(43) Pub. Date: Aug. 6, 2026

(54) METHOD AND DEVICE FOR SUPPORTING SELF-CONFIGURATION AND SELF-OPTIMIZATION

(71) Applicant: Samsung Electronics Co., Ltd., Suwon-si, Gyeonggi-do (KR)

(72) Inventors: Lixiang XU, Beijing (CN); Weiwei WANG, Beijing (CN); Hong WANG, Beijing (CN)

(21) Appl. No.: 19/151,843

(22) PCT Filed: Feb. 13, 2024
(86) PCT No.: PCT/KR2024/002023

§ 371 Date: Jul. 29, 2025

(30) Foreign Application Priority Data
Feb. 15, 2023 (CN) 202310171833.3
Feb. 16, 2023 (CN) 202310141262.9

(51) Int. Cl. H04W 36/30; H04W 36/00

(52) U.S. Cl. CPC H04W 36/305; H04W 36/0058

(57) ABSTRACT

The disclosure relates to a 5G or 6G communication system for supporting a higher data transmission rate. The disclosure provides a method of a user equipment (UE) in a wireless communication system, the method comprising: detecting a radio link failure (RLF) associated with a mobility failure for a voice fallback, wherein the voice fallback is associated with a handover of the UE from a first base station supporting a new radio (NR) to a second base station supporting an evolved-universal mobile telecommunications system terrestrial radio access network (E-UTRA); storing voice fallback indication information on the mobility failure for the voice fallback in an RLF report; and transmitting, to a third base station, an UE information response message including the RLF report.

### TECHNICAL FIELD

The present application relates to wireless communication technology, and more specifically, relates to a method and device for supporting self-configuration and self-optimization.

### BACKGROUND ART

Fifth generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multi input multi output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user con-venience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

### DISCLOSURE OF INVENTION

### Technical Problem

The present disclosure relates to wireless communication systems and, more specifically, the invention relates to method and device for supporting self-configuration and self-optimization.

### Solution to Problem

How to support self-configuration and self-optimization is a problem that needs to be solved at present.

A method performed by a UE in a wireless communication system, comprising:
the UE occurring a radio link failure, RLF;
the UE saving the radio link failure information, wherein the radio link failure information includes an indication information of mobility failure for voice fallback from NR;
the UE transmitting a UE information response message to a third base station; the UE information response message includes an RLF report, wherein the RLF report includes at least one of the following information:
measurement results of a serving cell, measurement results of neighboring cells, failed cell Identifier information, reestablishment cell Identifier information, failure type, time from receiving an RRC reconfiguration message including a handover command to failure, cell Identifier information of a previous primary cell, previous NR primary cell Identifier information, reconnection cell Identifier information, suitable cell Identifier information, reconnect cell Identifier information and re-establishment cell Identifier information.

Optionally, the suitable cell Identifier information or reconnect cell Identifier information includes a global cell Identifier and/or a tracking area code (TAC) of the cell. The suitable cell or reconnection cell is a cell suitable for UE access after failure or a cell in which UE reconnection is successful. The successfully reconnect cell includes a cell in which the UE successfully completes the RRC reestablishment process or a cell in which the UE successfully completes the RRC connection establishment process.

Optionally, the cell Identifier information includes a global cell Identifier, a tracking area code where the cell is located, a physical cell Identifier and/or frequency information.

Optionally, the measurement results of the serving cell or neighboring cells include measurement results of NR cell, E-UTRA cell and other radio access technology cells.

A method performed by a third base station in a wireless communication system comprising:
receiving an UE information response message transmitted by a UE, wherein the UE information response message includes an RLF report, wherein the RLF report includes at least one of the following information:
measurement results of a serving cell, measurement results of neighboring cells, failed cell Identifier information, reestablishment cell Identifier information, failure type, time from receiving an RRC reconfiguration message including a handover command to failure, cell Identifier information of a previous primary cell, previous NR primary cell Identifier information, reconnection cell Identifier information, suitable cell Identifier information, reconnect cell Identifier information and re-establishment cell Identifier information, and an indication information of mobility failure for voice fallback from NR;
transmitting the received RLF report to a second base station where the cell in which the failure occurred is located.

A method performed by a second base station in a wireless communication system, comprising:
receiving a message including an RLF report, wherein the RLF report includes at least one of the following information: measurement results of a serving cell, measurement results of neighboring cells, failed cell Identifier information, reestablishment cell Identifier information, failure type, time from receiving an RRC reconfiguration message including a handover command to failure, cell Identifier information of a previous primary cell, previous NR primary cell Identifier information, reconnection cell Identifier information, suitable cell Identifier information, reconnect cell Identifier information and re-establishment cell Identifier information, and an indication information of mobility failure for voice fallback from NR.
detecting the cause of the failure.

Optionally, the second base station transmitting a second message to a second mobility management entity; the second message includes at least one of the following: previous NR primary cell Identifier, the cell Identifier of the failed cell, the cell Identifier of the suitable cell, the RLF report, the indication information of mobility failure for voice fallback from NR, the NR primary cell Identifier, the cell Identifier of the failed cell, and the cell Identifier of the suitable cell.

Optionally, the second message includes at least one of the following: the indication information of mobility failure for voice fallback from NR, NR primary cell Identifier, cell Identifier of the failed cell, cell Identifier of the suitable cell, and/or the RLF report.

A UE comprising a transceiver and a controller, and the controller configured to perform the aforementioned method performed by the UE.

A third base station comprising a transceiver and a controller, and the controller configured to perform the aforementioned method performed by the third base station.

A second base station comprising a transceiver and a controller, and the controller configured to perform the aforementioned method performed by the second base station.

In an embodiment, the method of a user equipment (UE) in a wireless communication system, the method comprising: detecting a radio link failure (RLF) associated with a mobility failure for a voice fallback, wherein the voice fallback is associated with a handover of the UE from a first base station supporting a new radio (NR) to a second base station supporting an evolved-universal mobile telecommunications system terrestrial radio access network (E-UTRA); storing voice fallback indication information on the mobility failure for the voice fallback in an RLF report; and transmitting, to a third base station, an UE information response message including the RLF report.

In another embodiment, a method of a third base station in a wireless communication system, the method comprising: receiving, from a user equipment (UE), an UE information response message including a radio link failure (RLF) report; and transmitting, to a second base station where an RLF associated with a mobility failure for a voice fallback is occurred, the RLF report including voice fallback indication information on the mobility failure for the voice fallback, wherein the RLF associated with the mobility failure for the voice fallback is detected by the UE, and wherein the voice fallback is associated with a handover of the UE from a first base station supporting a new radio (NR) to the second base station supporting an evolved-universal mobile telecommunications system terrestrial radio access network (E-UTRA).

In yet another embodiment, a method of a second base station where a radio link failure (RLF) associated with a mobility failure for a voice fallback is occurred in a wireless communication system, the method comprising: receiving, from a third base station, an RLF report including voice fallback indication information on the mobility failure for the voice fallback; and detecting a cause of the RLF associated with the mobility failure for the voice fallback, wherein the RLF associated with the mobility failure for the voice fallback is detected by a user equipment (UE), and wherein the voice fallback is associated with a handover of the UE from a first base station supporting a new radio (NR) to the second base station supporting an evolved-universal mobile telecommunications system terrestrial radio access network (E-UTRA).

In yet another embodiment, a user equipment (UE) in a wireless communication system, the UE comprising: a transceiver; and a processor configured to: detect a radio link failure (RLF) associated with a mobility failure for a voice fallback, wherein the voice fallback is associated with a handover of the UE from a first base station supporting a new radio (NR) to a second base station supporting an evolved-universal mobile telecommunications system terrestrial radio access network (E-UTRA), store voice fallback indication information on the mobility failure for the voice fallback in an RLF report, and transmit, to a third base station, an UE information response message including the RLF report.

In yet another embodiment, a third base station in a wireless communication system, the third base station comprising: a transceiver; and a processor configured to: receive, from a user equipment (UE), an UE information response message including a radio link failure (RLF) report, transmit, to a second base station where an RLF associated with a mobility failure for a voice fallback is occurred, the RLF report including voice fallback indication information on the mobility failure for the voice fallback, wherein the RLF associated with the mobility failure for the voice fallback is detected by the UE, and wherein the voice fallback is associated with a handover of the UE from a first base station supporting a new radio (NR) to the second base station supporting an evolved-universal mobile telecommunications system terrestrial radio access network (E-UTRA).

In yet another embodiment, a second base station where a radio link failure (RLF) associated with a mobility failure for a voice fallback is occurred in a wireless communication system, the method comprising: a transceiver; and a processor configured to: receive, from a third base station, an RLF report including voice fallback indication information on the mobility failure for the voice fallback, and detect a cause of the RLF associated with the mobility failure for the voice fallback, wherein the RLF associated with the mobility failure for the voice fallback is detected by a user equipment (UE), and wherein the voice fallback is associated with a handover of the UE from a first base station supporting a new radio (NR) to the second base station supporting an evolved-universal mobile telecommunications system terrestrial radio access network (E-UTRA).

### Advantageous Effects of Invention

Advantages, and salient features of the invention will become apparent to those skilled in the art from the following detailed description, which, taken in conjunction with the annexed drawings, discloses exemplary embodiments of the invention.

### BRIEF DESCRIPTION OF DRAWINGS

FIG. 1 is a system architecture diagram of system architecture evolution (SAE).

FIG. 2 is a schematic diagram of the initial overall architecture of 5G.

FIG. 3 is a flowchart of method 1 according to an embodiment of the present invention.

FIG. 4 is a block diagram of a network node in a network according to the present invention.

FIG. 5 is a block diagram of a user equipment, UE, according to the present invention.

### MODE FOR THE INVENTION

In order to make the purpose, technical solution and advantages of the embodiment of the disclosure more clear, the technical solution of the embodiment of the disclosure will be described clearly and completely with the accompanying drawings. Obviously, the described embodiment is a part of the embodiment of the present disclosure, not the whole embodiment. Based on the described embodiments of the present disclosure, all other embodiments obtained by a person skilled in the art without creative labor belong to the scope of protection of the present disclosure.

Before undertaking the description of specific implementations below, it may be advantageous to set forth definitions of certain words and phrases used throughout this patent document. The term “couple” and its derivatives refer to any direct or indirect communication between two or more elements, whether those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. Likewise, the term “set” means one or more. Accordingly, a set of items can be a single item or a collection of two or more items.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

The terminologies used herein to describe embodiments of the application is not intended to limit and/or define the scope of the application. For example, unless otherwise defined, technical terminologies or scientific terminologies used in this disclosure should have their ordinary meanings as understood a person skilled in the art to which the application belongs.

It should be understood that “first”, “second” and similar words used in this disclosure do not indicate any order, quantity or importance, but are only used to dis-tinguish different components. Unless the context clearly indicates otherwise, similar words such as “a”, “an” or “the” in the singular form do not indicate a quantitative limitation, but indicate the existence of at least one.

As used herein, any reference to “an example” or “examples”, “an embodiment” or “embodiments” means that a particular element, feature, structure or characteristic described in connection with the embodiment is included in at least one embodiment. The appearances of the phrases “in an embodiment” or “in an example” in different parts of the specification are not necessarily all referring to the same embodiment.

As used herein, “a part” of things means “at least some” of the things, so it may mean less than all of the things or all of the things. Therefore, “a part” of things includes the whole things as a special case, that is, the whole thing is an example of a part of things.

It will be further understood that the term “including” or “containing” and similar words mean that the elements or objects appearing before the word cover the elements or objects listed after the word and their equivalents, without excluding other elements or objects. Similar words such as “connect” or “connected” are not limited to physical or mechanical connection, but can include electrical connection, whether direct or indirect. “Up”, “Down”, “Left” and “Right” are only used to indicate the relative positional relationship. When the absolute position of the described object changes, the relative positional relationship may also change accordingly.

The various embodiments discussed below for describing the principles of the present disclosure in this patent document are for illustration only and should not be construed as limiting the scope of the present disclosure in any way. Those skilled in the art will understand that the principles of the present disclosure can be implemented in any suitably arranged wireless communication system. For example, although the following detailed description of the embodiments of the present disclosure will focus on LTE and 5G communication systems, those skilled in the art can understand that the main points of the present disclosure can also be applied to other communication systems with similar technical backgrounds and channel formats with slight modifications without departing from the scope of the present disclosure. The technical solution of the embodiment of the application can be applied to various communication systems, for example, the communication system can include a global system for mobile communications (GSM) system, code division multiple access (CDMA) system, wideband code division multiple access (WCDMA) system, general packet radio service (GPRS), long term evolution (long term evolution, LTE) system, LTE frequency division duplex (FDD) system, LTE time division duplex (TDD), universal mobile telecommunications system (UMTS), worldwide interoperability for microwave access (WiMAX) communication system, 5th generation (5G) system or new radio (NR), etc. In addition, the technical solution of the embodiments of the application can be applied to future-oriented communication technologies. In addition, the technical solution of the embodiments of the application can be applied to future-oriented communication technologies.

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

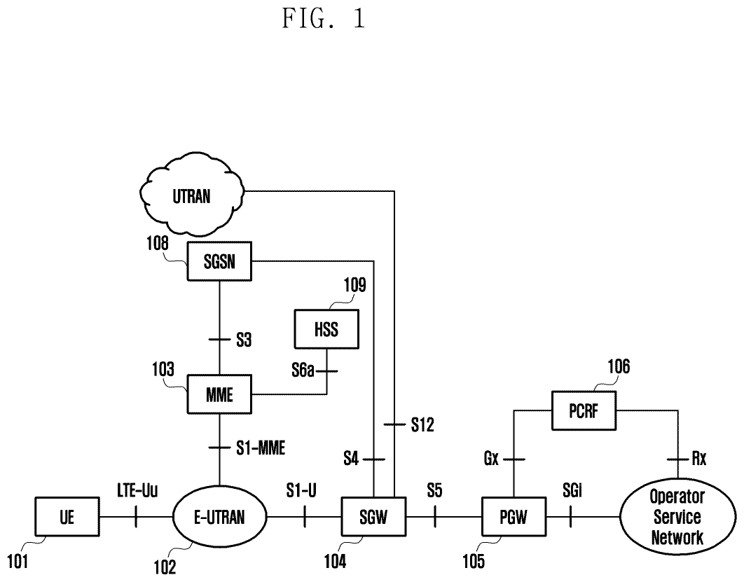

FIGS. 1 to 5 discussed below and various embodiments for describing the principles of the present disclosure in this patent document are only for illustration and should not be interpreted as limiting the scope of the disclosure in any way. Those skilled in the art will understand that the principles of the present disclosure can be implemented in any suitably arranged system or device.

FIG. 1 is an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QoS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

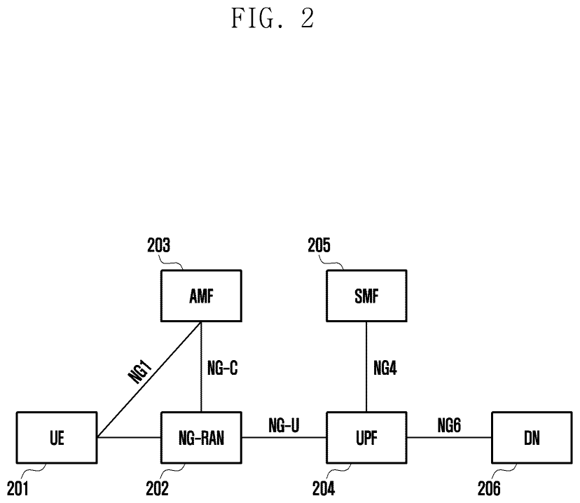

FIG. 2 is an exemplary system architecture 200 according to various embodiments of the present disclosure. Other embodiments of the system architecture 200 can be used without departing from the scope of the present disclosure.

User equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

Exemplary embodiments of the present disclosure are further described below with reference to the accompanying drawings.

The text and drawings are provided as examples only to help understand the present disclosure. They should not be interpreted as limiting the scope of the present disclosure in any way. Although certain embodiments and examples have been provided, based on the disclosure herein, it will be apparent to those skilled in the art that changes may be made to the illustrated embodiments and examples without departing from the scope of the present disclosure.

How to support the mobility robustness of handover for voice fallback is a problem that needs to be solved at present.

The invention supports the method of self-configuration and self-optimization, and can correctly identify the cause of failure in the case of inter-system handover for voice, so as to perform reasonable optimization, reduce the failure, ensure business continuity and reduce the labor cost of operators.

As understood by those skilled in the art, the “timer” described in this disclosure can also be called a timing device or a time-meter, and these terms are used inter-changeably in this disclosure.

Exemplary embodiments of the present disclosure are further described below with reference to the accompanying drawings.

The text and drawings are provided as examples only to help understand the present disclosure. They should not be construed as limiting the scope of the present disclosure in any way. Although certain embodiments and examples have been provided, based on the disclosure herein, it is obvious to those skilled in the art that changes can be made to the illustrated embodiments and examples without departing from the scope of this disclosure.

NR and LTE in the following description are only examples of different radio access technologies, RATs, and can also be other RATs, so the present invention is not limited to this.

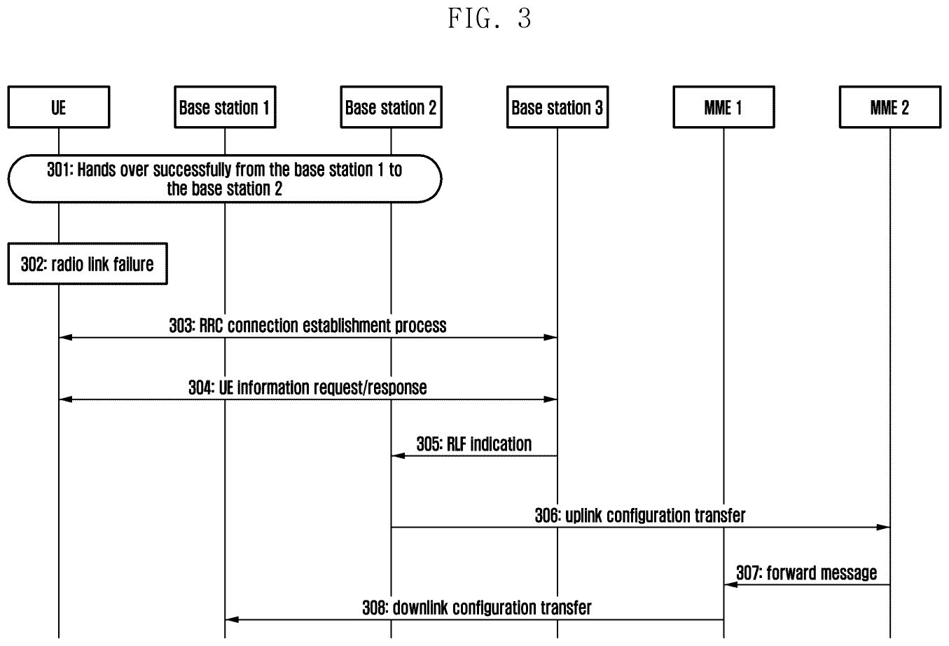

An example of the method 1 that supporting self-configuration and self-optimization in the present invention is shown in FIG. 3. The method comprises the following steps:

In step 301, the base station 1 hands over the UE to the base station 2. The base station 1 hands over the UE from the base station 1 to the base station 2 for voice fallback. Base stations 1 and 2 are the base stations supporting different wireless access technologies or the base stations of different systems. For example, the base station 1 is a base station supporting NR or a base station in NG-RAN, and the base station 2 is an LTE base station or an E-UTRAN base station. The handover process completed successfully.

Step 302: The UE occurs a radio link failure (RLF) in the cell of the base station 2. The UE saves the radio link failure information. The UE saves the radio link failure information in the RLF report variable.

The radio link failure information includes an indication information of mobility failure for voice fallback from NR. When mobility for voice fallback from NR fails, the radio link failure information includes the indication information of mobility failure for voice fallback from NR.

In step 303, the UE connects to the base station 3. The UE transmits an RRC connection request or an RRC connection reestablishment request message to the base station 3. The base station 3 transmits an RRC connection establishment or RRC connection re-establishment message to the UE. The UE transmits an RRC connection establishment completion or RRC connection re-establishment completion message to the base station 3.

If the RLF report variable include the information of the radio link failure or handover failure and the registered PLMN is included in the PLMN Identifier lists of the stored RLF report variable, the RLF report variable include suitable cell Identifier information or reconnect cell Identifier information or re-establishment cell Identifier information.

The suitable cell is a cell suitable for UE to access after failure, re-access after failure, re-connect after failure, establish or re-establish RRC connection after failure, or a cell selected by UE for attempting to establish or re-establish RRC connection after failure, successfully establishing or re-establishing RRC connection after failure, or the suitable cell selected by UE after failure.

If the UE supports inter-radio access technologies (Inter-RAT) Mobile Robustness Optimisation (MRO) RLF report, if the RLF report variable include the information of the radio link failure or handover failure and the registered PLMN is included in the PLMN Identifier lists of the stored RLF report variable, the RLF report variable include suitable cell Identifier information or reconnect cell Identifier information or re-establishment cell Identifier information.

When the re-establishment process is initiated after the mobility failure from NR, the RLF report includes the re-establishment cell Identifier information.

The suitable cell Identifier information or reconnect cell Identifier information includes a global cell Identifier and/or a tracking area code (TAC) of the cell. The suitable cell or reconnection cell is a cell suitable for UE to access or a cell in which UE reconnection is successful after failure. The successfully reconnect cell includes a cell in which the UE successfully completes the RRC reestablishment process or a cell in which the UE successfully completes the RRC connection establishment process.

The RRC connection establishment completion or RRC connection re-establishment completion message includes RLF information available. If the information of the radio link failure or handover failure is included in the RLF report variable and the registered PLMN is included in the PLMN Identifier lists of the stored RLF report variable, the RRC connection establishment completion or RRC connection re-establishment completion message includes RLF information available.

Step 304: The base station 3 transmits a UE information request message to the UE. The base station 3 transmits the UE information request message to the UE after receiving the RLF available information.

The UE transmits a UE information response message to the base station 3. The UE information response message includes an RLF report. The RLF report includes at least one of the following information: measurement results of a serving cell, measurement results of neighboring cells, failed cell Identifier information, reestablishment cell Identifier information, failure type, time from receiving an RRC reconfiguration message including a handover command to failure, cell Identifier information of a previous primary cell, previous NR primary cell Identifier information, reconnection cell Identifier information, indication information of mobility failure for voice fallback from NR, and suitable cell Identifier information. Therefore, the previous primary cell or the previous NR primary cell refers to the source cell of the last handover before the failure occurred.

The cell Identifier information includes a global cell Identifier, a tracking area code where the cell is located, a physical cell Identifier, and/or frequency information.

The measurement results of the serving cell or the neighboring cells include the measurement results of NR cell, E-UTRA cell and other radio access technology cells, and the present invention does not limit this.

For the handover failure from NR to E-UTRA base station, the base station 3 may be NR base station or E-UTRA base station. For the failure after the handover from NR to E-UTRA is completed, when the base station 3 is an NR base station, the UE information response message includes the cell Identifier information of the last serving cell, and the cell Identifier information of the last serving cell is included outside the RLF report in the UE information response message. The cell Identifier information that finally serves the UE is the Identifier information of the target cell in the base station 2. As such, upon the base station 3 receives the UE information response message, it can know the base station 2 according to the cell Identifier information of the last serving cell, without parsing the RLF report encoded in the E-UTRA RRC format, so as to forward the RLF report received from the UE to the base station 2. The base station 3 transmits the RLF report received from the UE to the base station 2 through the core network.

Step 305: The base station 3 transmits the received RLF report to the base station where the cell in which the failure occurred is located. The base station of the cell in which the failure occurred is base station 2. Wherein, the base station 3 can be a base station supporting the same radio access technology as the base station 2 or a base station supporting a different radio access technology, and the base station 3 can be a base station in the same system as the base station 2 or a base station in a different access system.

The base station 3 transmits the RLF report received from the UE to the base station 2 through the interface between base stations, or transmits the RLF report received from the UE to the base station 2 through the core network.

If the base station 3 and the base station 2 are base stations under the same system, for example, both are base stations of E-UTRAN, the base station 3 can transmit an RLF report to the base station 2 through an RLF indication message over the interface between base stations. The base station 3 can also transmit an RLF report to the base station 2 through other messages over the interface between base stations.

If there is no interface between the base station 3 and the base station 2 or the base station 3 and the base station 2 are base stations of different systems, the base station 3 transmits an RLF report to the base station 2 through the core network.

In step 306, the base station 2 detects the cause of the failure. The base station knows that mobility failure from NR for voice fallback according to the indication information of mobility failure from NR for voice fallback included in the RLF report. The following methods can also be used to detect the cause of the failure:
Before the failure, there is a recent inter-system handover of the UE from NR cell to the target cell, and the indication information of mobility failure from NR for voice fallback reported by UE is received, and the recent handover is known according to the timer reported by the UE is smaller than a configured threshold, wherein the timer reported by the UE is the time from the last HO initialization to the failure; or
Before the failure, there is a recent inter-system handover of the UE from NR cell to cell of E-UTRAN node, and the indication information of mobility failure for voice fallback from NR reported by UE is received, and the recent handover is known according to the timer reported by the UE is smaller than a configured threshold, wherein the timer reported by UE is the time from the last HO initialization to failure; or
Before the failure, there is a recent inter-system handover of the UE from NR cell to cell of E-UTRAN node, and the indication information of mobility failure for voice fallback from NR reported by UE is received. The UE connects to a cell of E-UTRAN node or to NR cell, and the recent handover is known according to the timer reported by the UE is smaller than a configured threshold, wherein the timer reported by UE is the time from the last HO initialization to failure; or
Receiving the indication information of mobility failure for voice fallback from NR reported by UE, the UE attempts the RRC connection establishment process in the cell of the E-UTRAN node or initiates the RRC re-establishment process in the NR cell, and the recent handover is known according to the timer reported by the UE is smaller than a configured threshold, wherein the timer reported by UE is the time from the last HO initialization to failure; or
Before the failure, there is a recent inter-system handover of the UE from NR cell to cell of E-UTRAN node, and the indication information of mobility failure for voice fallback from NR reported by UE is received. The cell that the UE successfully connected or reconnected is the cell of E-UTRAN node where the UE attempts the RRC establishment process or the cell of the NG-RAN node where the UE attempts the RRC re-establishment process, and the recent handover is known according to the timer reported by the UE is smaller than a configured threshold, wherein the timer reported by UE is the time from the last HO initialization to failure; or
Before the failure, there is a recent inter-system handover of the UE from NR cell to cell of E-UTRAN node, and the indication information of mobility failure for voice fallback from NR reported by UE is received. The UE selects an suitable E-UTRA cell to initiate the RRC connection establishment process or initiates the RRC connection establishment or re-establishment process in the source NR cell or other NR cells, and the recent handover is known according to the timer reported by the UE is smaller than a configured threshold, wherein the timer reported by UE is the time from the last HO initialization to failure; or
Before the failure, there is a recent inter-system handover to the UE from NR cell to cell of E-UTRAN node, and the indication information of mobility failure for voice fallback from NR reported by UE is received. The UE selects an suitable cell of E-UTRAN node to initiate the RRC connection establishment process for voice service or initiate the RRC connection establishment or re-establishment process in the cell of source NG-RAN node or other cells of NG-RAN node, and the recent handover is known according to the timer reported by the UE is smaller than a configured threshold, wherein the timer reported by UE is the time from the last HO initialization to failure.

The cell in which the UE connects to the E-UTRAN node can be said that the UE connects to the E-UTRA cell or to the E-UTRAN node.

Wherein, the above-mentioned that the cell in which the UE connects to the E-UTRAN node can be the cell in which the UE attempts to connect to the E-UTRAN node, the cell in which the UE attempts to establish RRC connection at the E-UTRAN node, the cell in which the UE attempts to establish RRC connection for voice service in the cell of E-UTRAN node, the cell in which the UE successfully connects to the E-UTRAN node, the cell in which the UE reconnects to the E-UTRAN node, the cell in which the UE successfully reconnects to the cell of the E-UTRAN node, the cell in which the UE reestablishes to the cell of the E-UTRAN node, or the cell in which the UE successfully reestablishes to the cell of the E-UTRAN node.

Wherein, the above-mentioned that UE connects to NR cell can be said that the cell in which the UE connects to NG-RAN node or the cell in which the UE connects to NG-RAN node.

Wherein, the above-mentioned that the cell in which the UE connects to the NG-RAN node can be the cell in which the UE attempts to connect to the NG-RAN node, the cell in which the UE initiated RRC reestablishment process at the NG-RAN node, the cell in which the UE initiated RRC connection establishment process at the NG-RAN node, the cell in which the UE successfully connects to the NG-RAN node, the cell in which the UE reconnects to the NG-RAN node, the cell in which the UE successfully reconnects to the NG-RAN node, the cell in which the UE reestablishes to the NG-RAN node, or the cell in which the UE successfully reestablishes to the NG-RAN node.

According to the Identifier information of the previous NR primary cell included in the RLF report, the base station 2 knows the source cell that triggered the handover for voice fallback. According to the cell Identifier of the failed cell, the base station 2 knows the target cell that handover for voice fallback. The base station 2 can also know the suitable cell Identifier. There are three ways for the base station 2 to know the suitable cell Identifier: method 1, the base station 2 knows the suitable cell Identifier from the Identifier information of the suitable cell included in the received RLF report; method 2, the base station 2 knows the suitable cell Identifier from the reconnect cell Identifier information or the re-establishment cell Identifier information included in the received RLF report; method 3, the base station 2 knows the suitable cell Identifier according to the measurement results in the received RLF report.

The base station 2 transmits an uplink configuration transfer message to the mobility management entity 2. If the base station 2 is in an enhanced packet system (EPS), the mobility management entity 2 is an MME. The uplink configuration transfer is an eNB configuration transfer message. The message includes the Identifier information of the source base station and the Identifier information of the target base station. The Identifier information of the source base station is the Identifier information of the base station 2. The Identifier information of the target base station is the Identifier information of the base station 1. The base station Identifier information includes a global cell Identifier and a selected tracking area Identifier (TAI). If the base station 2 is an eNB, the Identifier information of the source base station includes the global eNB Identifier and the selected EPS TAI. Base station 2 knows the global base station Identifier of base station 1 and the selected TAI from the previous NR primary cell Identifier information in the RLF report. The global base station Identifier can be known from the previous NR primary cell Identifier, and the selected TAI is the selected PLMN Identifier and tracking area code. If the base station 1 is an NR base station, the global base station Identifier is a global RAN node Identifier. The uplink configuration transfer message includes the Identifier of the previous NR primary cell, the Identifier of the failed cell, the Identifier of the suitable cell, the RLF report, and/or the mobility failure for voice fallback from NR. The base station 2 puts the indication information of mobility failure for voice fallback from NR, the NR primary cell Identifier, the cell Identifier of the failed cell, and/or the cell Identifier of the suitable cell in the RLF report into the uplink configuration transfer message. The NR primary cell Identifier is the previous NR primary cell Identifier. The uplink configuration transfer message may also include a new handover report type that mobility failure for voice fallback from NR. When the handover report type is for mobility failure for voice fallback from NR, the message may include the NR primary cell Identifier, the cell Identifier of the failed cell, the cell Identifier of the suitable cell, and/or the RLF report. The advantage that the base station 2 includes the NR primary cell Identifier, the cell Identifier of the failed cell, the cell Identifier of the suitable cell, and/or the indication information of mobility failure for voice fallback from NR (for example, the handover report type of mobility failure for voice fallback from NR) in the RLF report in the uplink transfer message is that even if the base station 1 cannot parse the RLF report encoded by the RRC supported by the base station 2, the base station 1 can know the failure type is mobility failure for voice fallback from NR, and can know the source NR cell, the target cell, and/or whether there is a suitable target cell for handover, so as to perform corresponding optimization. If the base station 1 receives the suitable cell Identifier, the base station 1 knows that there is an suitable cell and knows the cell Identifier of the suitable cell.

Step 307: The mobility management entity 2 forwards the received message to the mobility management entity 1. The mobility management entity 2 finds the mobility management entity 1 according to the selected TAI in the uplink configuration transfer message. If the base station 1 is in a 5G system, the mobility management entity 1 is AMF.

Step 308: The mobility management entity 1 transmits a downlink configuration transfer message to the base station 1. The information included in the downlink configuration transfer information is the same as that in the uplink configuration transfer message in step 306.

For example, it includes the Identifier information of the source base station and the Identifier information of the target base station. It also includes the Identifier of the previous NR primary cell, the Identifier of the failed cell, the Identifier of the suitable cell, the RLF report, and/or the mobility failure for voice fallback from NR. The downlink configuration transfer message may also include a new handover report type, which is the mobility failure for voice fallback from NR. When the handover report type is the mobility failure for voice fallback from NR, the message may include the NR primary cell Identifier, the cell Identifier of the failed cell, the cell Identifier of the suitable cell, and/or the RLF report. As such, the base station 1 can know the NR primary cell Identifier, the cell Identifier of the failed cell, and/or the cell Identifier of the suitable cell according to the received downlink configuration transfer message, even without parsing the RLF report, so as to perform corresponding optimization. If the base station 1 receives the suitable cell Identifier, the base station 1 knows that there is an suitable cell and knows the cell Identifier of the suitable cell. If the radio access technologies supported by the base station 1 and the base station 2 are different, the base station 1 may not be able to parse the RLF report encoded by RRC according to the radio access technology supported by the base station 2, so that the NR primary cell Identifier, the cell Identifier of the failed cell, and/or the cell Identifier of the suitable cell can be known according to the information included in the downlink configuration transfer message, so as to perform corresponding optimization.

After receiving the downlink configuration transfer message, the base station 1 can further detect or confirm the cause of the failure. The base station 1 detects or confirms the cause of the failure according to the received information, and the specific detection or confirmation method is the same as that in step 306, so the details are not repeated here.

Or the base station 1 knows the cause of the failure according to the received information of mobility failure for voice fallback from NR.

The base station 1 performs corresponding optimization according to the cause of the failure and the information included in the downlink configuration transfer message.

So far, the method 1 that supporting self-configuration and self-optimization of the present invention has been completed. By this method, the cause of failure can be correctly identified when the inter-system handover of voice fails, so as to perform reasonable optimization, reduce the failure, ensure business continuity and reduce the labor cost of operators.

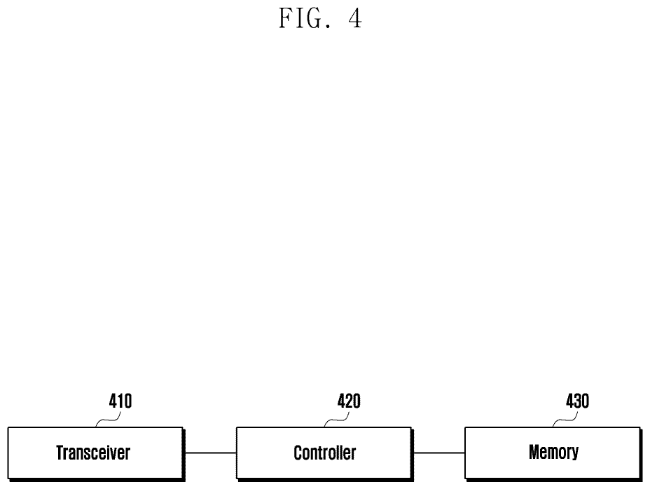

FIG. 4 is a block diagram of a network node in a network according to the present invention.

The network nodes in the network can be used to realize the UE, the first base station, the second base station, the third base station, the mobility management entity 1, the mobility management entity 2 and the like in the present invention. Referring to FIG. 4, the network nodes according to the present invention include a transceiver 410, a controller 420 and a memory 430. The transceiver 410, the controller 420 and the memory 430 are configured to perform the operations of the methods and/or embodiments of the present invention. Although the transceiver 410, the controller 420 and the memory 430 are shown as separate entities, which may be implemented as a single entity, such as a single chip. The transceiver 410, the controller 420 and the memory 430 may be electrically connected or coupled to each other. The transceiver 410 can transmit and receive signals to and from other network nodes, such as UE, MN, SN, S-SN, T-SN, other candidate T-SN or core network nodes. The controller 420 may include one or more processing units and may control the network nodes to perform operations and/or functions according to one of the above embodiments. The memory 430 may store instructions for implementing operations and/or functions of one of the embodiments described above.

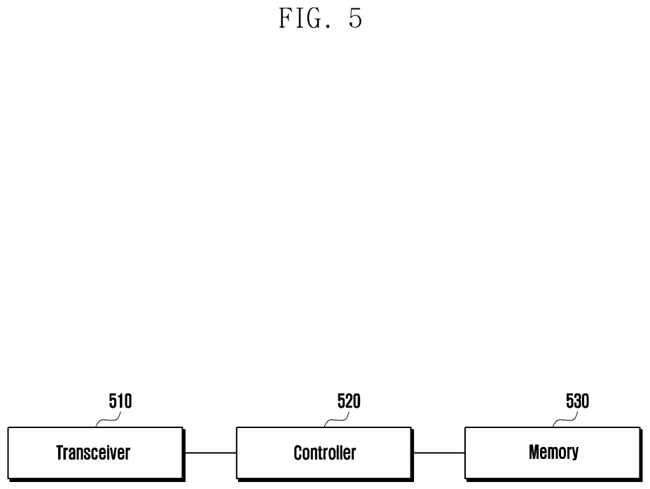

FIG. 5 is a block diagram of a user equipment, UE, according to the present invention.

Referring to FIG. 5, the UE according to the present invention includes a transceiver 510, a controller 520 and a memory 530. The transceiver 510, the controller 520 and the memory 530 are configured to perform the operations of the methods and/or embodiments of the present invention. Although the transceiver 510, the controller 520 and the memory 530 are shown as separate entities, which may be implemented as a single entity, such as a single chip. The transceiver 510, the controller 520 and the memory 530 may be electrically connected or coupled to each other. The transceiver 510 can transmit and receive signals to and from other network nodes, such as UE, MN, SN, S-SN, T-SN, other candidate T-SN or core network nodes. The controller 520 may include one or more processing units and may control the UE to perform operations and/or functions according to one of the above embodiments. The memory 530 may store instructions for implementing operations and/or functions of one of the embodiments described above.

Those skilled in the art will understand that the illustrative embodiments described above are described herein and are not intended to be limiting. It should be understood that any two or more of the embodiments disclosed herein can be combined in any combination. In addition, other embodiments may be utilized and other changes may be made without departing from the spirit and scope of the subject matter presented herein. It will be readily understood that aspects of the invention of the present disclosure, as generally described herein and shown in the accompanying drawings, can be arranged, substituted, combined, separated and designed in various different configurations, all of which are contemplated herein.

Those skilled in the art will appreciate that the various illustrative logical blocks, modules, circuits, and steps described herein may be implemented as hardware, software, or a combination of both. In order to clearly illustrate this interchangeability between hardware and software, various illustrative components, blocks, modules, circuits, and steps are generally described in the form of their function sets. Whether such the function sets are implemented as hardware or software depends on the specific application and the design constraints imposed on the overall system. Those skilled in the art can implement the described function sets in different ways for each specific application, but such design decisions should not be interpreted as causing a departure from the scope of this application.

The illustrative logic blocks, modules, and circuits described in this application may be implemented in a general-purpose processor, a Digital Signal Processor (DSP), an application specific integrated circuit(ASIC), Field Programmable Gate Array (FPGA) or other programmable logic devices, discrete gate or transistor logic, discrete hardware components, or any combination thereof designed to perform the functions described herein. A general-purpose processor may be a microprocessor, but in the alternative, the processor may be any conventional processor, controller, micro-controller, or state machine. A processor may also be implemented as a combination of computing devices, such as a combination of a DSP and a microprocessor, a plurality of microprocessors, one or more microprocessors cooperating with a DSP core, or any other such configuration.

The steps of a method or algorithm described in this application may be embodied directly in hardware, in a software module executed by a processor, or in a combination of both. Software modules may reside in RAM memory, flash memory, ROM memory, EPROM memory, EEPROM memory, registers, hard disks, removable disks, or any other form of storage media known in the art. An exemplary storage medium is coupled to a processor to enable the processor to read and write information from/to the storage medium. In the alternative, the storage medium may be integrated into the processor. The processor and storage medium may reside in an ASIC. The ASIC may reside in the user terminal. In the alternative, the processor and the storage medium may reside as separate components in the user terminal.

In one or more exemplary designs, the described functions may be implemented in hardware, software, firmware, or any combination thereof. If implemented in software, each function can be stored on or transmitted by a computer-readable medium as one or more instructions or codes. Computer-readable media include both computer storage media and communication media, and the latter includes any media that facilitates the transfer of computer programs from one place to another. The storage medium can be any available medium that can be accessed by a general-purpose or special-purpose computer.

The above is only an exemplary implementation of this application, and is not used to limit the protection scope of this application, which is determined by the appended claims.

1. A method of a user equipment (UE) in a wireless communication system, the method comprising:
detecting a radio link failure (RLF) associated with a mobility failure for a voice fallback, wherein the voice fallback is associated with a handover of the UE from a first base station supporting a new radio (NR) to a second base station supporting an evolved-universal mobile telecommunications system terrestrial radio access network (E-UTRA);
storing voice fallback indication information on the mobility failure for the voice fallback in an RLF report; and
transmitting, to a third base station, an UE information response message including the RLF report.

2. The method of claim 1,
wherein the RLF report includes at least one of measurement results of a serving cell, measurement results of neighboring cells, failed cell identifier information, suitable cell identifier information, or reconnect cell identifier information,
wherein the reconnect cell identifier information includes a global cell identifier or a tracking area code (TAC) of a reconnect cell, and
wherein the reconnect cell is a cell in which an UE reconnection is performed after the RLF.

3. The method of claim 2,
wherein the measurement results of the serving cell or the measurements of the neighboring cells include measurement results of a NR cell, or measurement results of an E-UTRA cell.

4. A method of a third base station in a wireless communication system, the method comprising:
receiving, from a user equipment (UE), an UE information response message including a radio link failure (RLF) report; and
transmitting, to a second base station where an RLF associated with a mobility failure for a voice fallback is occurred, the RLF report including voice fallback indication information on the mobility failure for the voice fallback,
wherein the RLF associated with the mobility failure for the voice fallback is detected by the UE, and
wherein the voice fallback is associated with a handover of the UE from a first base station supporting a new radio (NR) to the second base station supporting an evolved-universal mobile telecommunications system terrestrial radio access network (E-UTRA).

5. The method of claim 4,
wherein the RLF report includes at least one of measurement results of a serving cell, measurement results of neighboring cells, failed cell identifier information, suitable cell identifier information, or reconnect cell identifier information,
wherein the reconnect cell identifier information includes a global cell identifier or a tracking area code (TAC) of a reconnect cell, and
wherein the reconnect cell is a cell in which an UE reconnection is performed after the RLF.

6. The method of claim 5,
wherein the measurement results of the serving cell or the measurements of the neighboring cells include measurement results of a NR cell, or measurement results of an E-UTRA cell.

7. A method of a second base station where a radio link failure (RLF) associated with a mobility failure for a voice fallback is occurred in a wireless communication system, the method comprising:
receiving, from a third base station, an RLF report including voice fallback indication information on the mobility failure for the voice fallback; and
detecting a cause of the RLF associated with the mobility failure for the voice fallback,
wherein the RLF associated with the mobility failure for the voice fallback is detected by a user equipment (UE), and
wherein the voice fallback is associated with a handover of the UE from a first base station supporting a new radio (NR) to the second base station supporting an evolved-universal mobile telecommunications system terrestrial radio access network (E-UTRA).

8. The method of claim 7,
wherein the RLF report includes at least one of measurement results of a serving cell, measurement results of neighboring cells, failed cell identifier information, suitable cell identifier information, or reconnect cell identifier information,
wherein the reconnect cell identifier information includes a global cell identifier or a tracking area code (TAC) of a reconnect cell, and wherein the reconnect cell is a cell in which an UE reconnection is performed after the RLF.

9. A user equipment (UE) in a wireless communication system, the UE comprising:
a transceiver; and
a processor configured to:
detect a radio link failure (RLF) associated with a mobility failure for a voice fallback, wherein the voice fallback is associated with a handover of the UE from a first base station supporting a new radio (NR) to a second base station supporting an evolved-universal mobile telecommunications system terrestrial radio access network (E-UTRA),
store voice fallback indication information on the mobility failure for the voice fallback in an RLF report, and
transmit, to a third base station, an UE information response message including the RLF report.

10. The UE of claim 9,
wherein the RLF report includes at least one of measurement results of a serving cell, measurement results of neighboring cells, failed cell identifier information, suitable cell identifier information, or reconnect cell identifier information,
wherein the reconnect cell identifier information includes a global cell identifier or a tracking area code (TAC) of a reconnect cell, and
wherein the reconnect cell is a cell in which an UE reconnection is performed after the RLF.

11. The UE of claim 10,
wherein the measurement results of the serving cell or the measurements of the neighboring cells include measurement results of a NR cell, or measurement results of an E-UTRA cell.

12. A third base station in a wireless communication system, the third base station comprising:
a transceiver; and
a processor configured to:
receive, from a user equipment (UE), an UE information response message including a radio link failure (RLF) report,
transmit, to a second base station where an RLF associated with a mobility failure for a voice fallback is occurred, the RLF report including voice fallback indication information on the mobility failure for the voice fallback,
wherein the RLF associated with the mobility failure for the voice fallback is detected by the UE, and
wherein the voice fallback is associated with a handover of the UE from a first base station supporting a new radio (NR) to the second base station supporting an evolved-universal mobile telecommunications system terrestrial radio access network (E-UTRA).

13. The third base station of claim 12,
wherein the RLF report includes at least one of measurement results of a serving cell, measurement results of neighboring cells, failed cell identifier information, suitable cell identifier information, or reconnect cell identifier information,
wherein the reconnect cell identifier information includes a global cell identifier or a tracking area code (TAC) of a reconnect cell, and
wherein the reconnect cell is a cell in which an UE reconnection is performed after the RLF.

14. The third base station of claim 13,
wherein the measurement results of the serving cell or the measurements of the neighboring cells include measurement results of a NR cell, or measurement results of an E-UTRA cell.

15. A second base station where a radio link failure (RLF) associated with a mobility failure for a voice fallback is occurred in a wireless communication system, the method comprising:
a transceiver; and
a processor configured to:
receive, from a third base station, an RLF report including voice fallback indication information on the mobility failure for the voice fallback, and
detect a cause of the RLF associated with the mobility failure for the voice fallback,
wherein the RLF associated with the mobility failure for the voice fallback is detected by a user equipment (UE), and
wherein the voice fallback is associated with a handover of the UE from a first base station supporting a new radio (NR) to the second base station supporting an evolved-universal mobile telecommunications system terrestrial radio access network (E-UTRA).
